(19) United States
(12) Patent Application Publication
(10) Pub. No.: US 2010/0307701 A1
(43) Pub. Date: Dec. 9, 2010

(54) Integrated quiet Motorized Roller Shade System

(76) Inventor: Thomas Peterson, Cave Creek, AZ (US)

Correspondence Address: TIFFANY & BOSCO;CAMELBACK ESPLANADE II, THIRD FLOOR, 2525 EAST CAMELBACK ROAD, PHOENIX, AZ, 85016, US

(21) Appl. No.: 12/481,522

(22) Filed: Jun. 9, 2009

(51) Int. Cl. E06B 9/72; F16M 13/00; F16F 7/00

(52) U.S. Cl. 160/310; 267/136; 181/207

(57) ABSTRACT

A quiet motorized roller shade assembly has a roller tube for reeling and unreeling a reelable shade and an internal electric motor. The motor turns a drive wheel that mates with a the interior of the roller tube so that the roller tube rotates in response to the rotation of the drive wheel. The electric motor disposed within a motor sleeve for reducing sound transmission within the roller tube. A crown is disposed on one end of the roller tube. The drive wheel and the crown maintain a space between the electric motor and the roller tube so that the motor does not directly contact the roller tube. An idler assembly is disposed proximate the end of the roller tube opposite the crown. The idler assembly includes a spring member for reducing vibration between roller shade assembly and the mounting bracket during operation of the electric motor.

### BACKGROUND

This invention relates generally to motorized roller shades for windows. More particularly, it relates to an improved quiet motorized roller shade assembly having an electric motor disposed within the interior of a roller tube.

Window shade systems having flexible shades supported by elongated rollers are well known. The roller is rotatably supported within a window frame for winding receipt of the flexible shade. Known window shade systems include those having motor driven rollers.

Prior art motor drives for roller shades have a number of drawbacks, including noise generated by the moving parts of the system. The rollers of known motorized shade systems are typically hollow tubes. It is known to provide a motor drive for a window shade roller having a motor housed within an end of the roller tube. One advantage of such a configuration is that the positioning of the drive motor within the roller reduces the space required between the roller and the frame, thereby increasing the maximum length of roller that can be supported in the frame. Increased roller length provides for wider shades and narrower coverage gaps. The hollow tube and attached flexible shade, however, act as a natural loudspeaker that amplifies the noise generated by the drive motor.

It is an object of the present invention, therefore, to provide a motorized roller shade assembly having a motor housed within the roller tube that is quieter than prior art motorized roller shade assemblies.

Additional objects and advantages of the invention will be set forth in the description that follows, and in part will be apparent from the description, or may be learned by practice of the invention. The objects and advantages of the invention may be realized and obtained by means of the instrumentalities and combinations pointed out in the appended claims.

### SUMMARY OF THE INVENTION

To achieve the foregoing objects, and in accordance with the purposes of the invention as embodied and broadly described in this document, there is provided a quiet motorized roller shade assembly having a roller tube rotatable about a longitudinal axis for reeling and unreeling a reelable shade. An electric motor is generally disposed within the interior of the roller tube and has an output drive shaft for rotating the roller tube and a motor collar disposed about the motor head. A drive wheel is coupled to the output drive shaft so that the drive wheel rotates in response to the rotation of the drive shaft. According to one aspect of the invention, a motor sleeve is disposed within the interior of the roller tube for reducing sound transmission within the roller tube.

In one advantageous embodiment, the drive wheel has peripheral teeth and the interior of the roller tube has a complementary surface that mates with the drive wheel peripheral teeth so that the roller tube rotates in response to the rotation of the drive wheel. The drive wheel maintains a space between the electric motor and the roller tube so that the motor does not directly contact the roller tube. The drive wheel preferably comprises a material selected to dampen vibrations between the motor and the roller tube, such as a polyurethane material. A crown is disposed on one end of the roller tube for maintaining a space between the roller tube and motor so that the motor does not directly contact the roller tube. The crown preferably comprises a material selected to dampen vibrations between the motor and the roller tube, such as a polyurethane material.

According to yet another aspect of the invention, an idler assembly is disposed proximate the end of the roller tube opposite the crown. The idler assembly includes a shaft adapted to engage a mounting bracket for supporting the roller shade assembly and a spring member for reducing vibration between the shaft and the mounting bracket during operation of the electric motor.

The roller shade assembly can include a sound-absorbing material disposed within a space between the electric motor and an end of the roller tube for reducing sound transmission within the roller tube. In one advantageous embodiment, the sound-absorbing material is a foam material.

### BRIEF DESCRIPTION OF THE DRAWINGS

The accompanying drawings, which are incorporated in and constitute a part of the specification, illustrate the presently preferred embodiments of the invention, and together with the general description given above and the detailed description of the preferred methods and embodiments given below, serve to explain the principles of the invention.

FIG. 1 is a perspective view of a prior art motorized roller tube system including a motor housed within an end of the roller tube;

FIG. 2 is a partial cut-away perspective view of a motorized roller shade assembly according to the present invention, showing the assembly without the roller tube;

FIG. 3 is a perspective view of the roller tube for the assembly of FIG. 2;

FIG. 4 is an end view showing the cross-section of the roller tube of FIG. 3;

FIG. 5 is a perspective view showing the crown of the assembly of FIG. 2 in more detail;

FIGS. 6A, 6B and 6C are front, side and rear views, respectively, of the crown of FIG. 5;

FIGS. 7A, 7B and 7C are front, side and rear views, respectively, showing the drive wheel of the assembly of FIG. 2 in more detail;

FIG. 8 is a perspective view showing the idler assembly of the roller shade assembly of FIG. 2 in more detail;

FIG. 9 is a perspective view showing the interior idler hub of the assembly of FIG. 8 in more detail;

FIGS. 10A and 10B are front and side views, respectively, of the interior idler hub of FIG. 9;

FIG. 11 is a perspective view showing the exterior idler hub of the assembly of FIG. 8 in more detail; and

FIGS. 12A, 12B and 12C are front, side and rear views, respectively, of the exterior idler hub of FIG. 11.

FIG. 13 is an enlarged front view showing the idler assembly of FIG. 8 mounted in a mounting bracket.

FIG. 14 is an enlarged front view showing the motor head of the assembly of FIG. 2 mounted in a mounting bracket.

### DETAILED DESCRIPTION

Reference will now be made in more detail to presently preferred methods and embodiments of the invention, as illustrated in the accompanying drawings. While the invention is described more fully with reference to these examples and drawings, the invention in its broader aspects is not limited to the specific details, representative devices, and illustrative examples shown and described. Rather, the description which follows is to be understood as a broad, teaching disclosure directed to persons of ordinary skill in the appropriate arts, and not as limiting upon the invention.

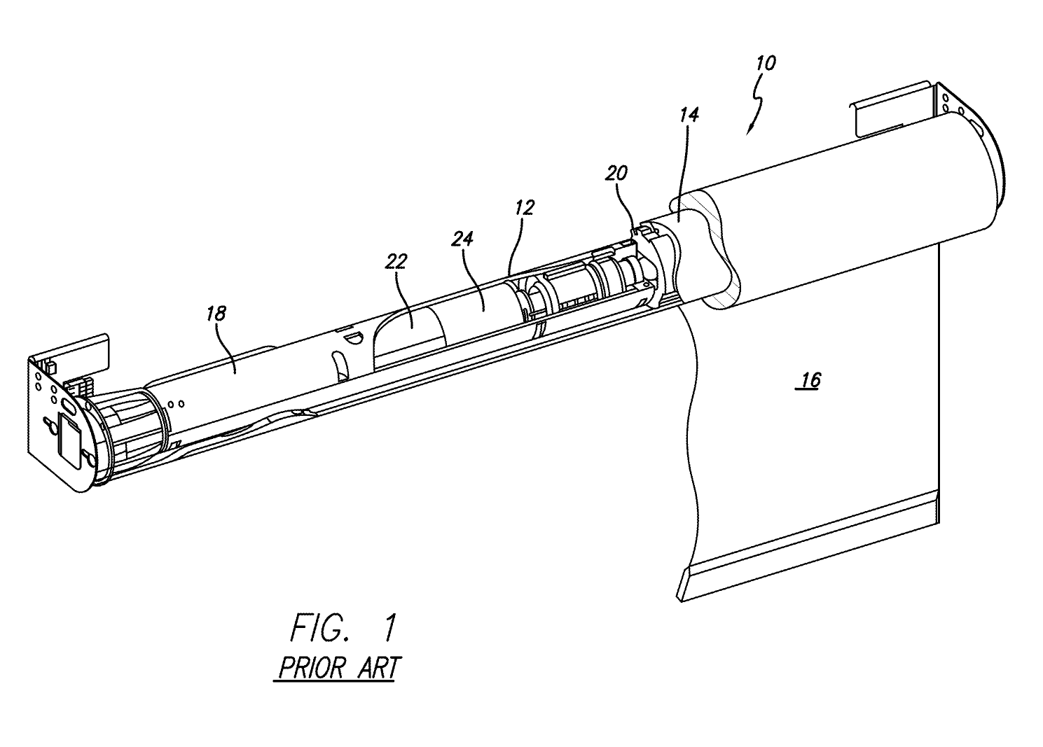

Referring to FIG. 1, there is shown a prior art motorized roller tube system 10 having a motor housed within an end of the roller tube. The motorized roller tube system 10 includes a rotatably supported roller tube 14 and a flexible member 16, such as a window shade fabric, windingly received by the roller tube 14. The flexible shade member 16 is typically engaged to the roller tube 14 by securing an end portion of the flexible member 16 to the roller tube 14. A roller tube drive assembly 12 drives the roller tube 14 in opposite rotational directions for winding and unwinding the flexible member 16 about the roller tube 14. The prior drive assembly 12 includes an elongated housing 18 and a puck 20 located adjacent an end of the housing 18. The puck 20 engages an inner surface of the roller tube 14 to drive the roller tube 14 as the puck is rotated by the drive assembly 12.

Still referring to FIG. 1, the prior roller tube drive assembly 12 includes a motor 22 and gear assembly 24 located within an interior of the housing 18 and connected to the puck 20. The motor 22 of prior drive assembly 12 is a DC electric motor. The drive assembly 12 is received within the interior of the roller tube 14. For this reason, this type of roller tube drive assembly is referred to as an “internal” drive assembly. Other known motorized roller tube systems include drive assemblies that are located externally of the roller tube.

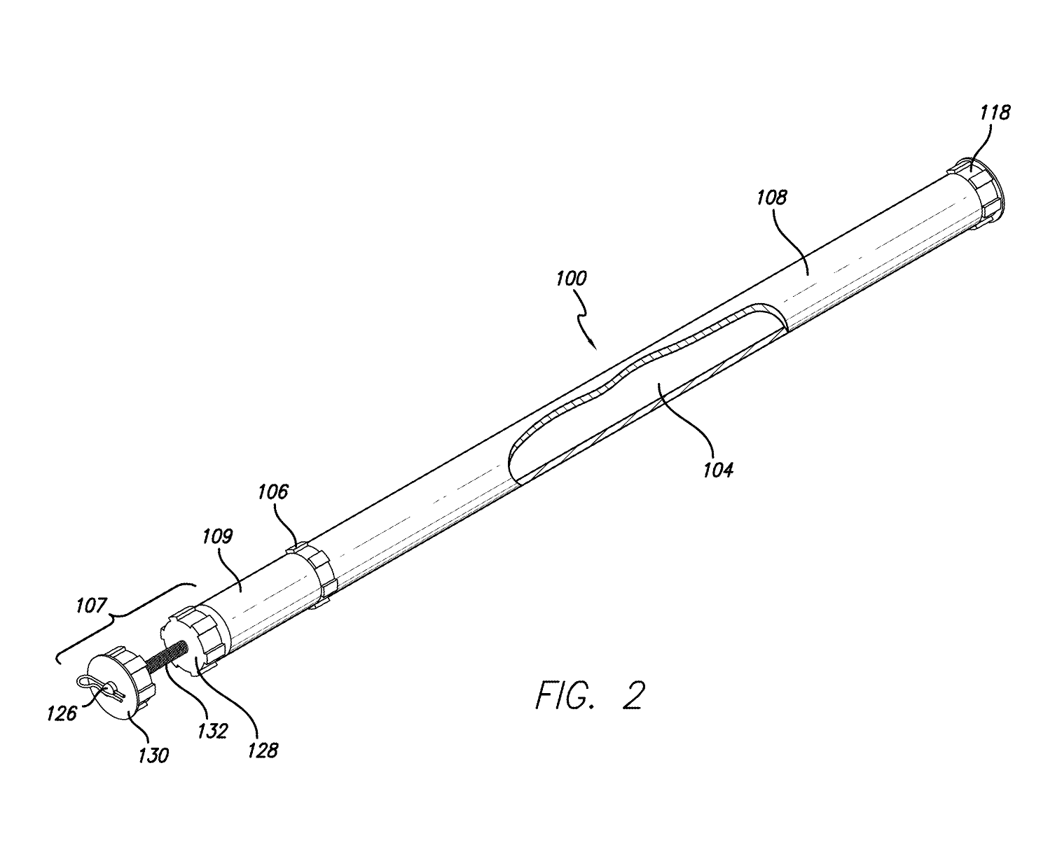

Referring to FIG. 2, there is shown a motorized roller shade assembly 100 according to the present invention. The motorized roller shade assembly 100 includes a roller tube 102 that rotates about a longitudinal axis for reeling and unreeling a reelable shade (not shown). Within the roller tube 102 is disposed a motor sleeve 108 for reducing transmission of sound. Within the motor sleeve 108 is disposed an electric motor 104 having an output drive shaft (not shown) coupled to a drive wheel 106. As described in more detail below, the motor 104 and drive wheel 106 rotate the roller tube 102 to reel or unreel a flexible shade member (not shown) from the roller tube 102. In a preferred embodiment, the electric motor 104 is generally tubular in shape, having a length of about 24-30 inches, and has a collar 149 adjacent a motor head 150 that protrudes from one end of the roller tube 102 and is held in a mounting bracket 152 (see FIG. 14). One suitable type of motor is the RTS series of tubular motors marketed in North America by Somfy Systems, Inc. of Cranbury, N.J. A crown 118 is disposed at the end of the roller tube 102 opposite the drive wheel 106.

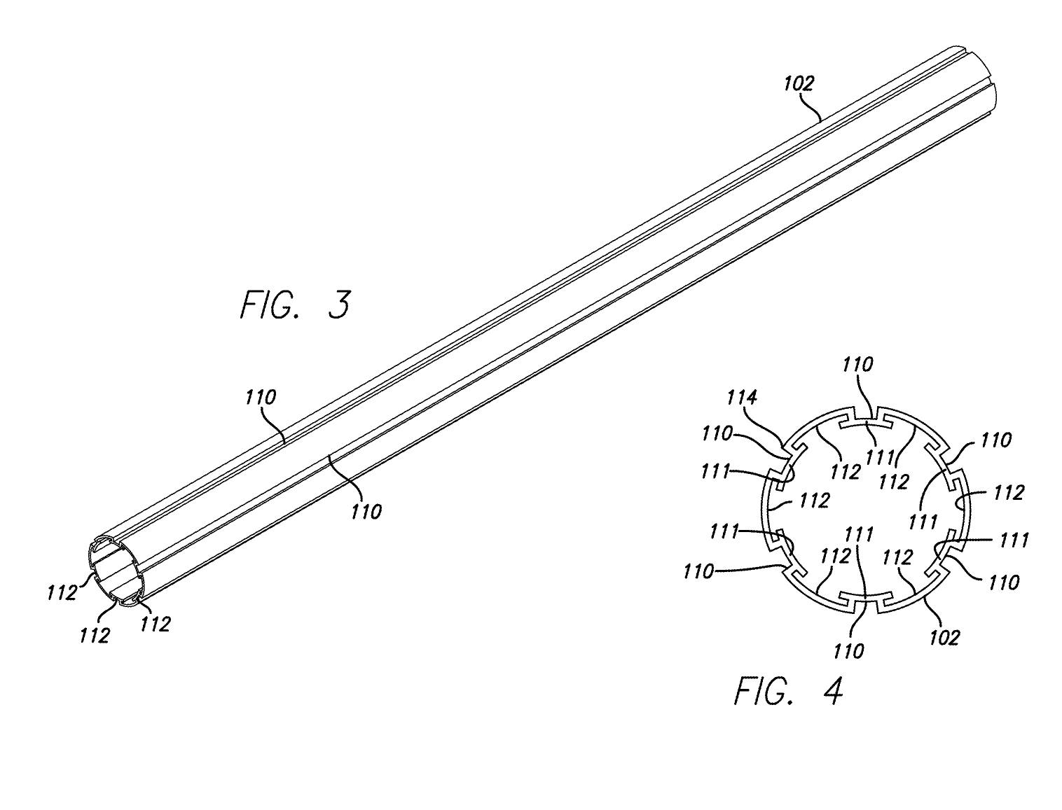

The roller tube 102 is cut to an appropriate length depending on the window opening in which the roller shade assembly 100 is mounted. The roller tube 102 may be made from any material that is sufficiently rigid to support the weight of a shade fabric; such as, without limitation, aluminum, steel, or carbon composite. Referring to FIGS. 3 and 4, in a presently preferred embodiment, the roller tube 102 is fabricated from an aluminum alloy. The dimensions of this preferred embodiment of the roller tube are shown in FIG. 4. The roller tube 102 is formed with longitudinal grooves 110 on the outer surface, which provide a more rigid tube structure and allow the roller tube 102 to have a greater length for use with wider shades without unwanted tube deflection. Also in this configuration, the interior of the roller tube 102 defines a plurality of interior longitudinal ribs 111 and channels 112 that accept and tightly mate with the drive wheel 106 as described in more detail below. The interior longitudinal ribs 11 define an inner diameter ID that is greater than the motor collar outer diameter. The roller tube 102 also has a longitudinal ridge 114 to aid in properly aligning the edge of the flexible shade material on the roller tube. The shade material preferably is secured to the roller tube 102 with tape, but can be secured using other known means such as a spline.

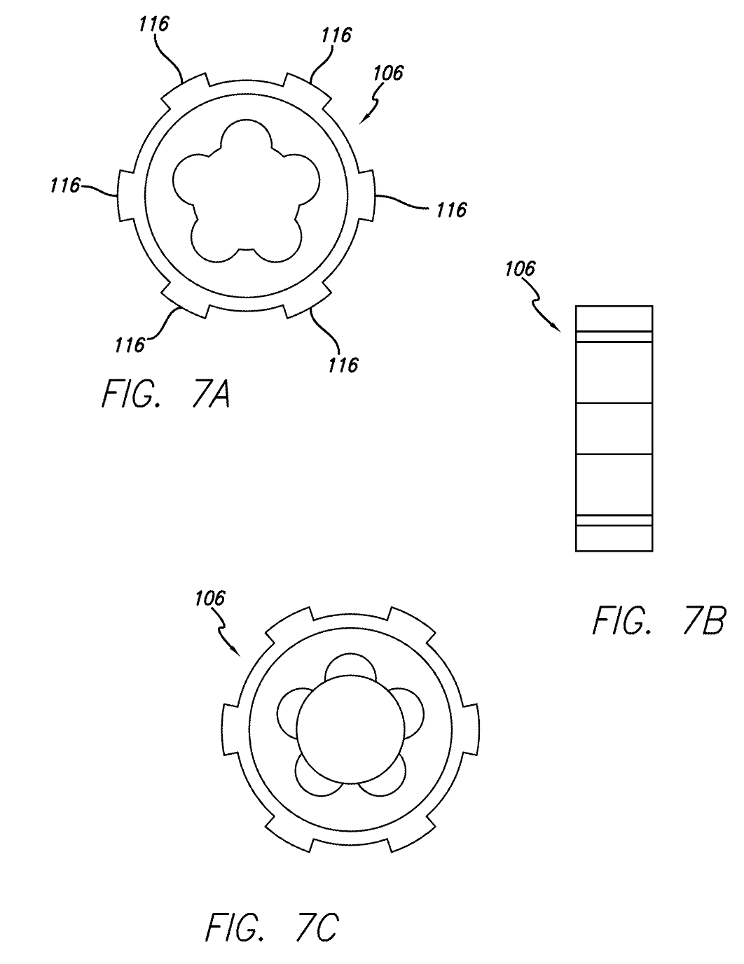

Referring again to FIG. 2, the drive wheel 106 is coupled to an output drive shaft (not shown) of the electric motor 104 so that the drive wheel 106 rotates in response to the rotation of the drive shaft. As shown in FIGS. 2, 7 and 8, the drive wheel 106 includes a number of peripheral teeth 116 that are accepted by and tightly mate with the roller tube channels 112. In this configuration, the roller tube peripheral teeth 116 tightly mate with the complementary surface on the interior of the roller tube 102 so that the roller tube rotates in response to the rotation of the drive wheel 106. Preferably, the drive wheel 106 comprises a material selected to dampen vibrations between the motor and the roller tube. In one preferred embodiment, the drive wheel 106 is molded from a polyurethane material. FIG. 7 shows the dimensions of such an embodiment of the drive wheel 106 for mating with the roller tube 102 having the dimensions shown in FIG. 4. A screw can be inserted through the roller tube 102 and threaded into the drive wheel 106 to hold the drive wheel 106 in position along the longitudinal axis of the roller tube 102.

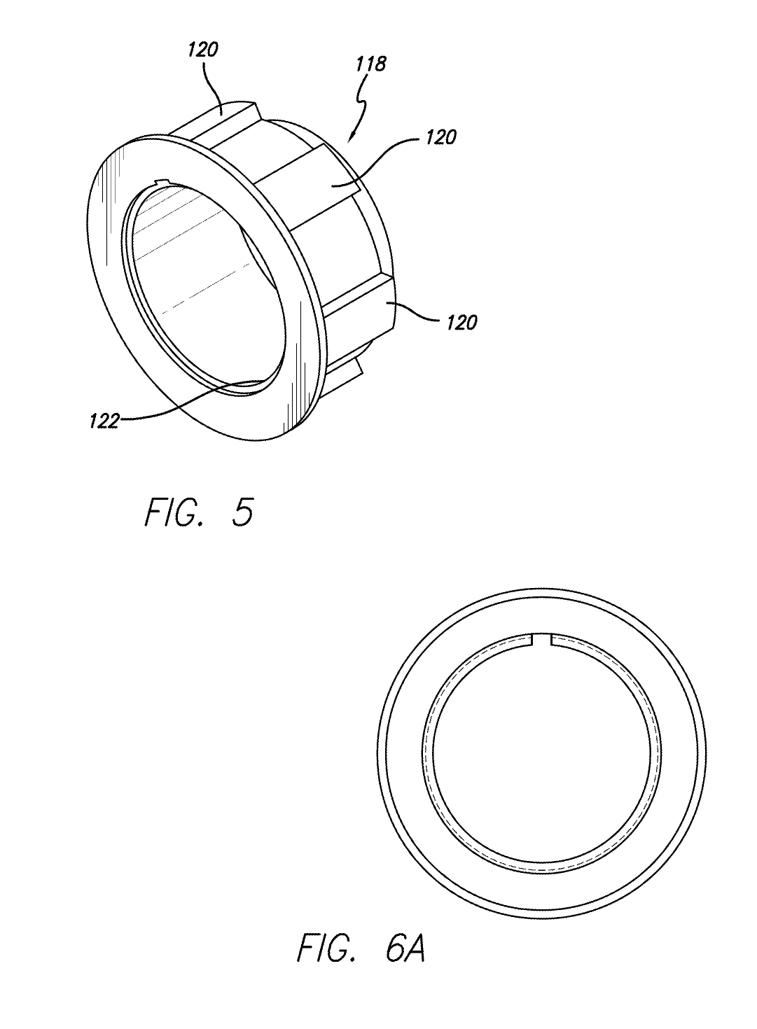

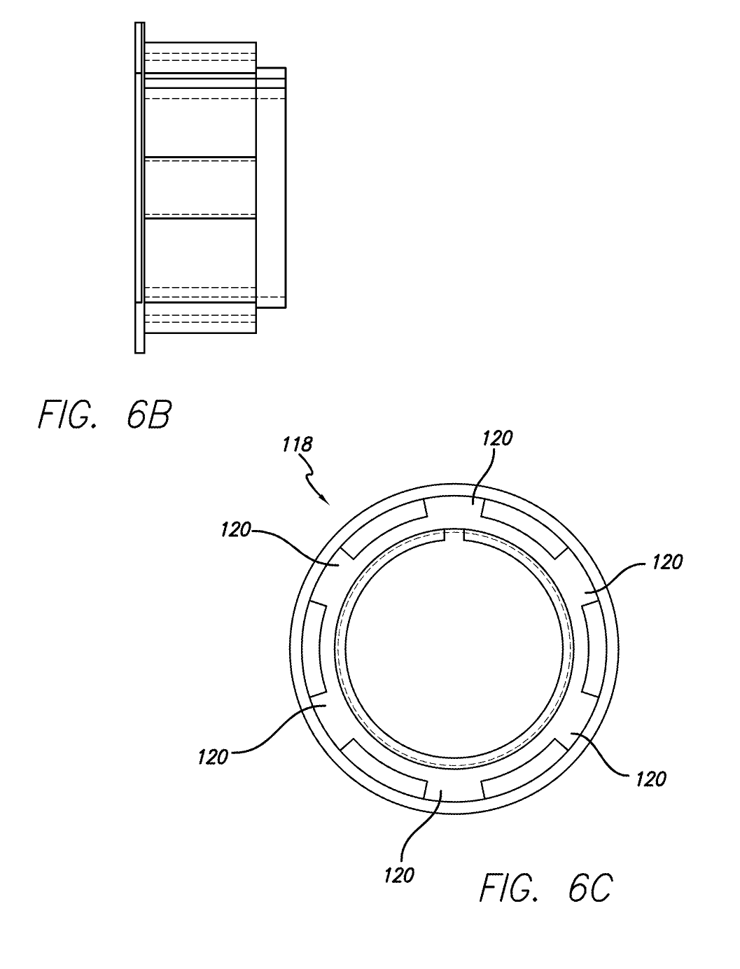

Referring to in FIGS. 2, 5 and 6, the crown 118 includes a number of peripheral teeth 120 that are accepted by and tightly mate with the roller tube channels 112. In this configuration, the crown peripheral teeth 120 tightly mate with the complementary surface on the interior of the roller tube 102 so that the crown 118 rotates in response to the rotation of the roller tube 102. The crown 118 includes a center hole 122 that fits over the motor collar 149. Preferably, the crown 116 comprises a material selected to dampen vibrations between the motor and the roller tube. In one preferred embodiment, the crown 118 is molded from a polyurethane material. FIG. 6 shows the dimensions of such an embodiment of the crown 118 for mating with the roller tube 102 having the dimensions shown in FIG. 4. In this configuration, no screw needs to be inserted through the roller tube 102 and threaded into the crown 118, as has been required by prior art.

Referring again to FIG. 2, the motor sleeve 108 is disposed within the interior of the roller tube 102 for reducing transmission of sound. The drive wheel 106 is fitted into one end of the motor sleeve 108 and the crown 118 is fitted on the other end of the motor sleeve 108. The drive wheel 108 has a center hole for motor drive shaft and the crown 118 has a lip that fits tightly into the motor sleeve 108. In this configuration, the drive wheel 106 and crown 118 act as spacing members for maintaining a space between the motor sleeve 108 and the roller tube 102 so that they do not directly contact each other. According to a preferred embodiment, the motor sleeve 108 is fabricated from a material including a vinyl ester resin and fiberglass.

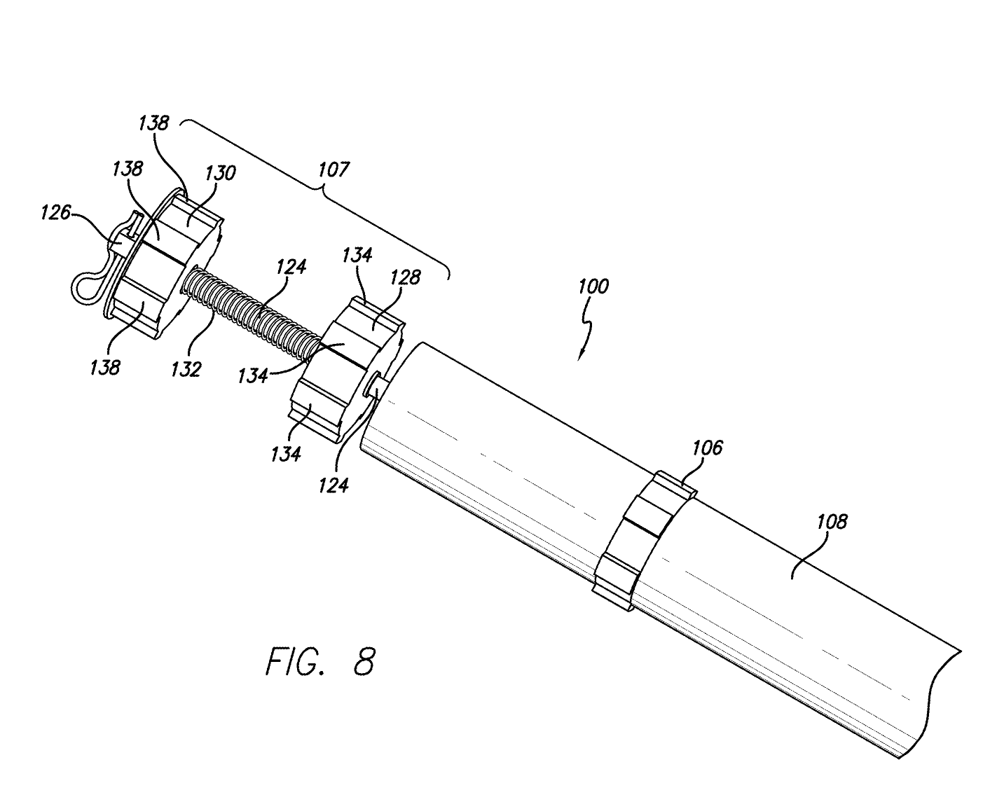

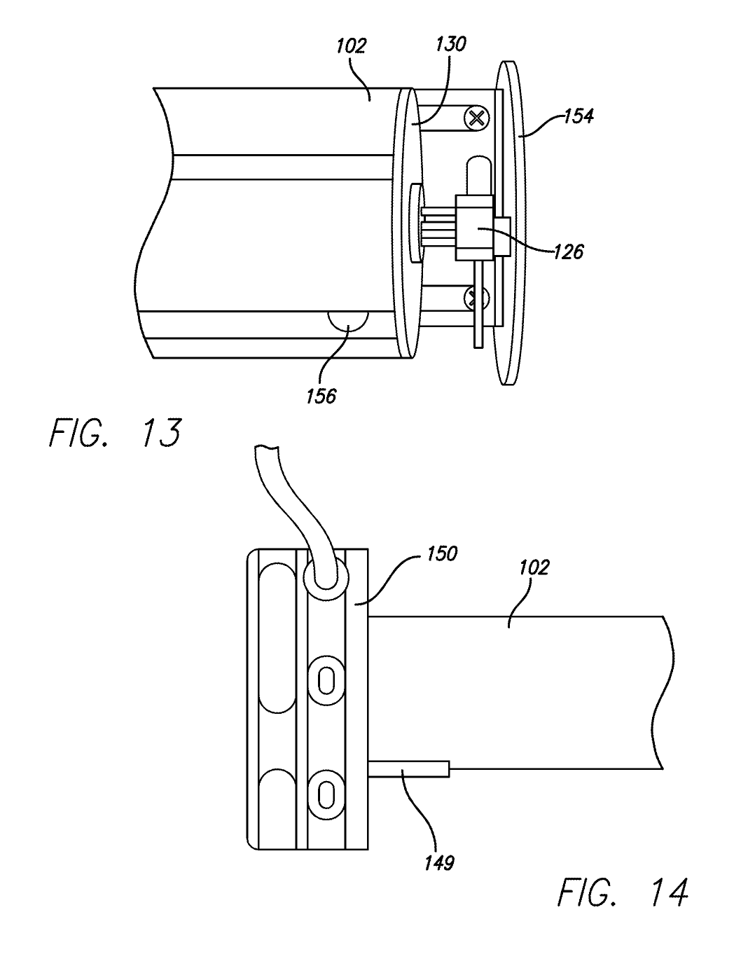

Referring to FIGS. 2 and 8, an idler assembly 107 is disposed at the end of the roller tube 102 opposite the crown 118. The idler assembly 107 includes an idler shaft 124 oriented generally along the longitudinal axis of the roller tube 102. The idler shaft 124 has an enlarged cap on one end and an enlarged head 126 on the other end, which is sized to be held in a mounting bracket 154 (see FIG. 13) that supports the roller shade assembly 10 so that it cannot rotate. An interior idler hub 128 is rotatably mounted on the cap end of the idler shaft 124 and an exterior idler hub 130 is rotatably mounted on the opposing end of the idler shaft 124. A compressible coil spring 132 is mounted on the idler shaft 124 between the idler hubs 128, 130. The spring 132 helps reduce vibration between the idler shaft 124 and the mounting bracket during operation of the electric motor, as discussed below.

After the motorized roller shade assembly of FIG. 2 is assembled, it is mounted between the mounting brackets 152, 154, so that the coil spring 132 is compressed with the idler assembly 107 inserted into the roller tube 102. To mount the roller shade assembly in the brackets 152, 154, the idler shaft enlarged head 126 is pulled outward and seated in the bracket 154. This pulls the interior idler hub 128 toward the end of the roller shade assembly, which places a compression load on the coil spring 132. The idler shaft cap is pressed against the interior idler hub 128 and holds it on the idler shaft 124. In a preferred embodiment, the compression load is achieved by compressing the coil spring 132 about ⅛-⅝ inch. The exterior idler hub 130 is held in place in the end of the roller tube 102 by a screw 156 inserted through the roller tube 102 and threaded into the hub 130 (see FIG. 13). In this configuration, the compression of coil spring 132 reduces sound vibrations between the idler shaft 124 and the mounting bracket 154 during operation of the electric motor.

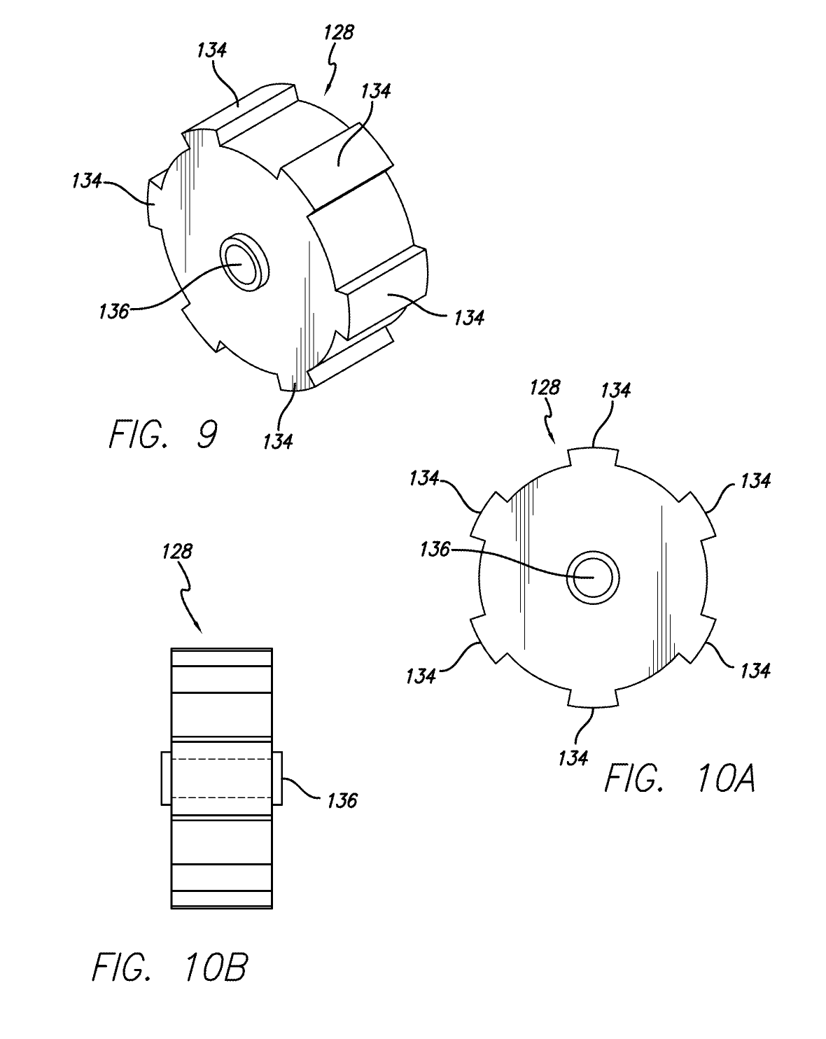

As can best be seen in FIGS. 9 and 10, the interior idler hub 128 includes a number of peripheral teeth 134 that are accepted by and tightly mate with the roller tube channels 112. In this configuration, the interior idler hub peripheral teeth 134 mate with the complementary surface on the interior of the roller tube 102 so that the interior idler hub 128 rotates on the idler shaft 124 in response to the rotation of the roller tube 102. The interior idler hub 128 includes a center hole 136 for receiving the idler shaft 124. Preferably, interior idler hub 128 comprises a material selected to dampen vibrations between the motor and the roller tube. In one preferred embodiment, the interior idler hub 128 is molded from a polyurethane material. FIG. 10 shows the dimensions of such an embodiment of the interior idler hub 128 for mating with the roller tube 102 having the dimensions shown in FIG. 4. In this configuration, no screw needs to be inserted through the roller tube 102 and threaded into the interior idler hub 128, as has been required by prior art.

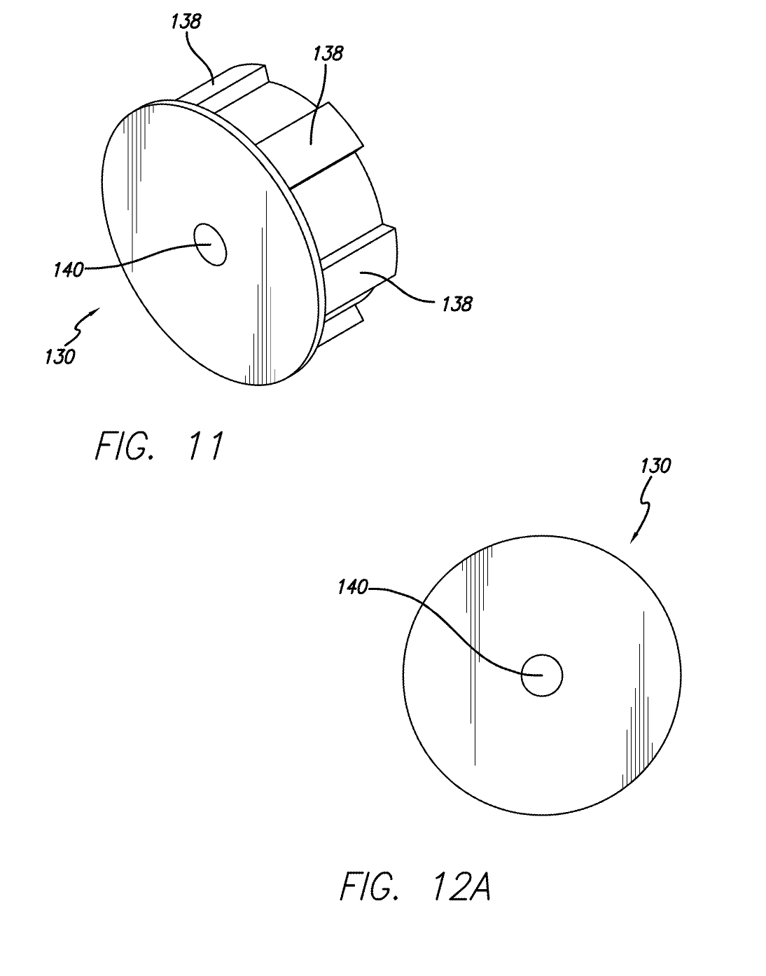

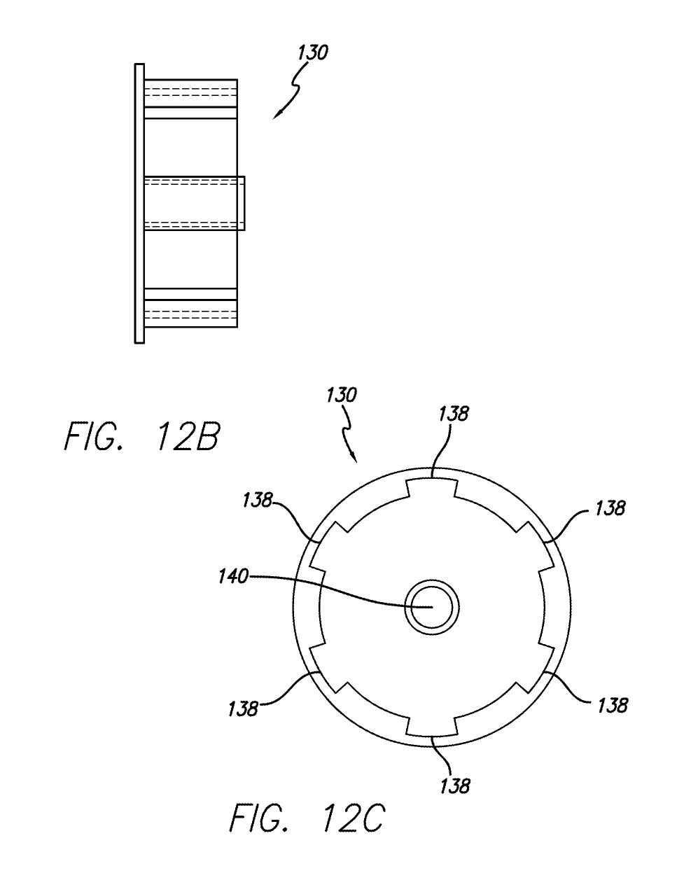

As can best be seen in FIGS. 11 and 12, the exterior idler hub 130 includes a number of peripheral teeth 138 that are accepted by and tightly mate with the roller tube channels 112. In this configuration, the exterior idler hub peripheral teeth 138 mate with the complementary surface on the interior of the roller tube 102 so that the exterior idler hub 130 rotates on the idler shaft 124 in response to the rotation of the roller tube 102. The exterior idler hub 130 includes a center hole 140 for receiving the idler shaft 124. Preferably, the exterior idler hub 130 comprises a material selected to dampen vibrations between the motor and the roller tube. In one preferred embodiment, the exterior idler hub 130 is molded from a polyurethane material. FIG. 12 shows the dimensions of such an embodiment of the exterior idler hub 130 for mating with the roller tube 102 having the dimensions shown in FIG. 4.

Referring again to FIG. 2, because the electric motor 104 is shorter in length than the roller tube 102 and the idler assembly 107, there is a space inside the roller tube between the motor 104 and the idler assembly 107. As shown in FIG. 2, a sound-absorbing material 109 is disposed within this space to help prevent resonance of the roller tube 102. In a preferred embodiment, the sound-absorbing material comprises a foam material.

In operation, when the motor 104 is turned on, it rotates the drive wheel 106, which in turn rotates the roller tube 102. The roller tube then rotates the crown 118 as well as the idler hubs 128, 130, which rotate on the idler shaft 124. The idler shaft 124 remains in a fixed position with respect to the mounting bracket.

It will be apparent that quiet operation is highly desirable for such apparatus used in home and office applications. Prior motor operated window shade apparatus have had a significant drawback of noisy operation. A number of features are employed in the novel structure of the invention, which substantially reduce motor noise while raising and lowering the shade. For example, the motor sleeve reduces the transmission of sound vibrations from the motor to rest of the assembly. The crown and drive wheel provide spacing between the electric motor and the roller tube so that neither the motor nor the motor collar directly contacts the roller tube. Because the crown and drive wheel are fabricated from a polyurethane material and tightly mate with the interior of the roller tube, they reduce sound vibrations between motor and the roller tube. The idler assembly reduces sound vibrations between the idler shaft and the mounting bracket during operation of the electric motor. Because the idler hubs are fabricated from a polyurethane material and tightly mate with the interior of the roller tube, they reduce sound vibrations between the roller tube and the mounting bracket. Thus, the invention provides a motorized roller shade assembly having an internal motor that is quieter than prior art motorized roller shade assemblies.

Having read this disclosure, it will also be understood by those having skill in the art that modifications may be made to the invention without departing from its spirit and scope. Therefore, the invention in its broader aspects is not limited to the specific details, representative devices, and illustrative examples shown and described. Accordingly, departures may be made from such details without departing from the spirit or scope of the general inventive concept.

What is claimed is:

1. A quiet motorized roller shade assembly comprising:
a roller tube rotatable about a longitudinal axis for reeling and unreeling a reelable shade; and
a tubular electric motor generally disposed within the interior of the roller tube and having a motor head adjacent an end of the tube, a motor collar disposed about the motor head, and an output drive shaft for rotating the roller tube;
a spacing member for maintaining a space between the electric motor collar and the roller tube so that neither the motor nor the motor collar directly contacts the roller tube.

2. The roller shade assembly of claim 1 wherein the spacing member comprises a material selected to dampen vibrations between the motor and the roller tube.

3. The roller shade assembly of claim 1 wherein the spacing member comprises a polyurethane material.

4. The roller shade assembly of claim 1 wherein the spacing member comprises a crown disposed over the motor collar.

5. The roller shade assembly of claim 1 wherein the spacing member comprises a drive wheel disposed on the output drive shaft.

6. A quiet motorized roller shade assembly comprising:
a roller tube rotatable about a longitudinal axis for reeling and unreeling a reelable shade;
an electric motor disposed within the interior of the roller tube and having an output drive shaft for rotating the roller tube; and
a drive wheel coupled to the output drive shaft so that the drive wheel rotates in response to the rotation of the drive shaft, wherein the drive wheel has at least one peripheral tooth and the interior of the roller tube has a complementary surface that mates with the drive wheel peripheral tooth so that the roller tube rotates in response to the rotation of the drive wheel.

7. The roller shade assembly of claim 6 wherein the roller tube complementary surface comprises a channel disposed generally parallel to the longitudinal axis and along a length of the interior of the roller tube.

8. The roller shade assembly of claim 6 wherein the drive wheel has a plurality of peripheral teeth and the interior of the roller tube has a plurality of corresponding complementary surfaces, wherein each of the complementary surfaces mates with one of the drive wheel peripheral teeth so that the roller tube rotates in response to the rotation of the drive wheel.

9. The roller shade assembly of claim 8 wherein each of the roller tube complementary surfaces comprises a channel disposed generally parallel to the longitudinal axis and along a length of the interior of the roller tube.

10. The roller shade assembly of claim 6 wherein the drive wheel comprises a material selected to dampen vibrations between the motor and the roller tube.

11. The roller shade assembly of claim 6 wherein the drive wheel comprises a polyurethane material.

12. A quiet motorized roller shade assembly comprising:
a roller tube having a first end and an opposing second end, the roller tube being rotatable about a longitudinal axis for reeling and unreeling a reelable shade;
an electric motor generally disposed within the interior of the roller tube and having an output drive shaft for rotating the roller tube;
an idler assembly disposed proximate an end of the roller tube, wherein the idler assembly includes a support member adapted to engage a mounting bracket for supporting the roller shade assembly and a spring member for reducing vibration between the support member and the mounting bracket during operation of the electric motor.

13. The roller shade assembly of claim 12 wherein the idler assembly comprises an idler shaft oriented generally along the longitudinal axis.

14. The roller shade assembly of claim 13 wherein the spring member comprises a compressible spring mounted on the idler shaft.

15. The roller shade assembly of claim 13 wherein the idler assembly further includes:
a first idler hub rotatably mounted on the idler shaft and coupled to the roller tube so that the idler hub rotates in response to rotation of the roller tube; and
a second idler hub rotatably mounted on the idler shaft opposite the first idler hub;
wherein the spring member is mounted on the idler shaft between the first and second idler hubs.

16. The roller shade assembly of claim 15 wherein one or more of the idler hubs comprises a material selected to dampen transmission of vibrations from the roller shade assembly to the bracket.

17. The roller shade assembly of claim 15 wherein one or more of the idler hubs comprises a polyurethane material.

18. A quiet motorized roller shade assembly comprising:
a roller tube rotatable about a longitudinal axis for reeling and unreeling a reelable shade;
a tubular electric motor having a housing and an output drive shaft for rotating the roller tube; and
a motor sleeve disposed within the interior of the roller tube for reducing transmission of sound;
wherein the electric motor is disposed, at least in part, within the interior of the motor sleeve.

19. The roller shade assembly of claim 18 wherein the motor sleeve comprises a composite material including a vinyl ester resin and fiberglass.

20. The roller shade assembly of claim 18 further comprising a spacing member for maintaining a space between the motor sleeve and the roller tube so that the motor sleeve does not directly contact the roller tube.

21. The roller shade assembly of claim 20 wherein the spacing member comprises a material selected to dampen vibrations between the motor and the roller tube.

22. The roller shade assembly of claim 20 wherein the spacing member comprises a polyurethane material.

23. The roller shade assembly of claim 20 wherein the spacing member comprises a crown disposed on one end of the roller tube.

24. The roller shade assembly of claim 20 wherein the spacing member comprises a drive wheel disposed on the output drive shaft.

25. The roller shade assembly of claim 24 wherein the drive wheel comprises a polyurethane material.

26. The roller shade assembly of claim 18 further comprising a crown disposed at an end of the roller tube.

27. The roller shade assembly of claim 26 wherein the crown comprises a polyurethane material.

28. The roller shade assembly of claim 18 further comprising a drive wheel coupled between the output drive shaft and the roller tube for rotating the roller tube when the drive shaft rotates.

29. The roller shade assembly of claim 28 wherein the drive wheel comprises a polyurethane material.

30. A quiet motorized roller shade assembly comprising:
a roller tube rotatable about a longitudinal axis for reeling and unreeling a reelable shade and having a length;
an electric motor generally disposed within the interior of the roller tube and having a length that is less than the length of the roller tube, whereby there is a space between an end of the electric motor a corresponding end of the roller tube; and
a sound-absorbing material disposed within the space between the electric motor and the roller tube end.

31. The roller shade assembly of claim 30 wherein the sound-absorbing material comprises a foam material.

32. A quiet motorized roller shade assembly comprising:
a roller tube rotatable about a longitudinal axis for reeling and unreeling a reelable shade; and
an electric motor generally disposed within the interior of the roller tube and having an output drive shaft for rotating the roller tube;
the roller tube and electric motor are disposed so that the roller tube motor does not directly contact the motor;
a motor sleeve disposed within the interior of the roller tube for reducing sound transmission within the roller tube;
a crown disposed on one end of the roller tube for maintaining a space between the roller tube and motor so that the motor does not directly contact the roller tube;
a drive wheel coupled to the output drive shaft so that the drive wheel rotates in response to the rotation of the drive shaft, wherein the drive wheel has at least one peripheral tooth and the interior of the roller tube has a complementary surface that mates with the drive wheel peripheral tooth so that the roller tube rotates in response to the rotation of the drive wheel and wherein the drive wheel maintains a space between the electric motor and the roller tube so that the motor does not directly contact the roller tube; and
an idler assembly disposed proximate an end of the roller tube, wherein the idler assembly includes a support member adapted to engage a mounting bracket for supporting the roller shade assembly and a spring member for reducing vibration between the support member and the mounting bracket during operation of the electric motor.

33. The roller shade assembly of claim 32 wherein one or more of the crown and the drive wheel comprises a material selected to dampen vibrations between the motor and the roller tube.

34. The roller shade assembly of claim 32 wherein the one or more crown and the drive wheel comprises a polyurethane material.

35. The roller shade assembly of claim 32 further comprising a sound-absorbing material disposed within a space between the electric motor and an end of the roller tube for reducing sound transmission within the roller tube.

36. The roller shade assembly of claim 35 wherein the sound-absorbing material comprises a foam material.

37. A quiet motorized roller shade assembly comprising:
a roller tube rotatable about a longitudinal axis for reeling and unreeling a reelable shade, wherein the roller tube has an inner diameter;
a generally tubular electric motor disposed within the interior of the roller tube;
a motor collar disposed on the motor and having an outer diameter, wherein the roller tube inner diameter is greater than the motor collar outer diameter; and
a spacing member for maintaining a space between the electric motor collar and the roller tube so that neither the motor nor the motor collar directly contacts the roller tube.

38. A quiet motorized roller shade assembly comprising:
a roller tube rotatable about a longitudinal axis for reeling and unreeling a reelable shade;
an electric motor generally disposed within the interior of the roller tube and having an output drive shaft for rotating the roller tube; and
a drive wheel coupled to the output drive shaft so that the drive wheel rotates in response to the rotation of the drive shaft, wherein the drive wheel has at least one peripheral tooth; and
wherein the interior of the roller tube defines a surface that accepts and tightly mates with the drive wheel peripheral tooth so that the roller tube rotates in response to the rotation of the drive wheel.

39. The roller shade assembly of claim 38 further comprising a crown disposed on one end of the roller tube, wherein the crown has at least one peripheral tooth and the roller tube defines a surface that accepts and tightly mates with the crown peripheral tooth.

40. The roller shade assembly of claim 38 wherein the interior of the roller tube comprises a plurality of longitudinal ribs for defining the surface that accepts and tightly mates with the drive wheel peripheral tooth.

41. The roller shade assembly of claim 39 wherein the interior of the roller tube comprises a plurality of longitudinal ribs for defining the surface that accepts and tightly mates with the crown peripheral tooth.

42. The roller shade assembly of claim 39 wherein the exterior of the roller tube comprises a longitudinal ridge for properly aligning shade on the roller tube.
